(19) United States
(12) Patent Application Publication
(10) Pub. No.: US 2016/0226966 A1
(43) Pub. Date: Aug. 4, 2016

(54) TASK MANAGEMENT AMONG MULTIPLE SERVERS

(71) Applicant: Tencent Technology (Shenzhen) Company Limited, Shenzhen (CN)

(72) Inventor: Liangmin LIN, Shenzhen (CN)

(21) Appl. No.: 15/097,884

(22) Filed: Apr. 13, 2016

Related U.S. Application Data
(63) Continuation of application No. PCT/CN2014/088256, filed on Oct. 10, 2014.

(30) Foreign Application Priority Data
Oct. 15, 2013 (CN) 201310481996.8

(51) Int. Cl. H04L 29/08; H04L 12/911

(52) U.S. Cl. CPC H04L 67/1021; H04L 47/781

(57) ABSTRACT

This application discloses a method for assigning a task on a computer network. In response to a request received for implementing a task, a task assignment server identifies a first location associated with the task, and obtains location information that indicates locations of a plurality of servers on the computer network. In accordance with a predetermined task assignment model, each of the plurality of servers has a respective distance from the first location which is computed based on the respective location information of the respective server. The server further identifies at least one server of the plurality of servers and assigns the task to the identified at least one server, when a distance between the first location and a second location of the at least one server is less than any other distances between the first location and the other servers of the plurality of servers.

### PRIORITY CLAIM AND RELATED APPLICATIONS

This application is a continuation application of PCT Patent Application No. PCT/CN2014/088256, entitled “TASK MANAGEMENT AMONG MULTIPLE SERVERS” filed on Oct. 10, 2014, which claims priority to Chinese Patent Application No. 201310481996.8, entitled “SERVICE DISTRIBUTION METHOD AND SYSTEM” filed on Oct. 15, 2013, both of which are incorporated by reference in their entirety.

### TECHNICAL FIELD

The disclosed implementations relate generally to the field of computer technology, and in particular, to methods and systems for assigning tasks among a plurality of computational machines that are communicatively coupled on a computer network.

### BACKGROUND

A computer implemented task operation normally requires support from one or more servers. As the number of task operations increases, the number of servers applied to support the task operations also increases, such that each of the task operations can be assigned to more than one server and implemented by these servers with the help of each other. Task assignment among the servers on a computer network is critical to the efficiency of implementing the task operations.

Specifically, data are generated in an online computer game, and need to be collected and processed to support subsequent operations (e.g., decision-making concerning task operations and strategies). Various gaming data processing systems have been developed to serve this purpose. Such gaming data processing systems oftentimes have to analyze gaming data generated by different games or different tasks of a single game. Therefore, such a gaming data analysis system is implemented by more than one server, and the gaming data originated from different gaming sources are assigned among these servers and analyzed at the respective assigned servers.

Under some circumstances, analysis of the gaming data involves historical data that have been generated from previous gaming operations and stored in a database. For example, when a new user is registered with the online computer game, some of his or her status data may have to be computed from user inputted data, default data, and/or historical data for users having a similar background. How to allocate the task of computing the status data among available computational machines directly impacts the computational efficiency of the gaming data analysis system, and the potential cost of a disaster recovery treatment, and many other aspects of the online gaming system.

Efficient data management oftentimes requires that the same task or related tasks be consistently assigned to and implemented on a specific server. As such, data generated from the same task or the related tasks are stored in a database hosted by the specific server, and would be conveniently extracted without communicating with remote machines during the course of implementing the same task or the related tasks again. However, despite improvement on data management, a data processing system are still plagued with a limited efficiency of implementing multiple tasks under the following two circumstances:
when the scale of the online game supported by the gaming data processing system increases dramatically, and the load of the computational machines are so high that more computational machines has to be incorporated onto the computer network to run the online game; and
when some malfunctioning computational machines are removed and disabled from supporting the online game.

Under these two circumstances, original task assignment has to be changed to accommodate above machine addition or removal. When a specific task is reassigned to a new machine, corresponding data associated with the specific task have to be moved out of a database located on an old machine, and stored in another database of the new machine. Sometimes, when addition or removal of a computational machine requires a large scale of task reassignment associated with the online game, the above process of relocating the corresponding data associated with the specific task would involve many computational machines, which increases the cost of task reassignment and compromises the overall performance of the online game. Therefore, there is a need for a method to reduce the scale of task reassignment, when one or more computational machines are added to or removed from the corresponding computer network which implements a software application (e.g., an online game).

### SUMMARY

The above deficiencies and other problems associated with the conventional approaches of task allocation are reduced or eliminated by the application disclosed below. In some embodiments, the application is implemented on a server that has one or more processors, memory and one or more modules, programs or sets of instructions stored in the memory for performing multiple functions. Instructions for performing these functions may be included in a computer program product configured for execution by one or more processors.

One aspect of the application is a computer-implemented method for assigning a task on a computer network. The method is implemented on a task assignment server, and includes receiving a request to implement a task on the computer network. The method further includes identifying a first location associated with the task, and obtaining location information for the plurality of servers. The location information indicates a respective location of each of the plurality of servers on the computer network. The method further includes identifying at least one server of the plurality of servers to implement the task and assigning the task to the identified at least one server. In accordance with a predetermined task assignment model, each of the plurality of servers has a respective distance from the first location, and the respective distance is computed based on the respective location information of the respective server. Further, in accordance with a predetermined task assignment model, a distance between the first location and a second location of the at least one server is less than any other distances between the first location and the other servers of the plurality of servers.

Another aspect of the application is a server that includes one or more processors and memory having at least one program (including instructions) stored thereon, which when executed by the one or more processors causes the processors to perform operations to implement the above task assignment method described above.

Another aspect of the application is a non-transitory computer readable storage medium that stores at least one program configured for execution by at least one processor of an electronic device. The at least one program includes instructions for causing a server to perform the operations in the task assignment method described above.

Other embodiments and advantages may be apparent to those skilled in the art in light of the descriptions and drawings in this specification.

### BRIEF DESCRIPTION OF DRAWINGS

The aforementioned implementation of the application as well as additional implementations will be more clearly understood as a result of the following detailed description of the various aspects of the application when taken in conjunction with the drawings. Like reference numerals refer to corresponding parts throughout the several views of the drawings.

The drawings illustrated herein are configured to providing further understanding on the application, contribute one part of the application. The exemplary embodiments of the application and explanations thereof are configured to explaining the application, but are not intended to inappropriately define the application. In the drawings:

FIGS. 1A and 1B illustrate flow diagrams representing two exemplary methods for assigning a task on a computer network in accordance with some embodiments in the application.

FIG. 2 illustrates an exemplary data analysis system that analyzes data associated with tasks implemented on a computer network in accordance with some embodiments in the application.

FIG. 3 illustrates an exemplary predetermined task assignment model.

FIGS. 4 and 5 illustrate flow diagrams representing another two exemplary methods for assigning a task on a computer network in accordance with some embodiments in the application.

FIGS. 6-8 illustrate block diagrams for three exemplary task assignment systems in accordance with some embodiments in the application.

FIG. 9 illustrates an exemplary data analysis system that analyzes gaming data associated with an online game implemented on a computer network in accordance with some embodiments in the application.

FIG. 10 illustrates a space model of an exemplary data analysis system that analyzes gaming data according to the embodiments of the application.

FIG. 11 illustrates a block diagram of a task assignment server that includes a task assignment module in accordance with some embodiments in the application.

Like reference numerals refer to corresponding parts throughout the several views of the drawings.

### DETAILED DESCRIPTION

In order to make those skilled in the art to better understand the solution of the application, the technical solution in the embodiments of the application will be described clearly and completely with reference to the drawings in the embodiments of the application. Apparently, the embodiments described are merely a part of embodiments of the application, rather than all embodiments of the application. Based on the embodiments in the application, all other embodiments made by a person of ordinary skill in the art without any creative effort, shall fall within the protection scope of the application.

It should be noted that such terms as “the first”, “the second” and the like in the specification and claims as well as the drawings of the application are configured to distinguishing similar objects, and are not intended to describe specific order or sequence. It should be understood that the objects or steps using in this way may be exchanged under proper situations so that the embodiments of the application described here can be implemented in other order than those illustrated or described here. Furthermore, the terms “include” and “provided with” as well as all variants thereof are intended to cover non-exclusive inclusion. For example, a process, method, system, product or system including a series of steps or units are not limited to the steps or units clearly listed, and may include other steps or units which are not clearly listed or inherent to the process, method, product or system.

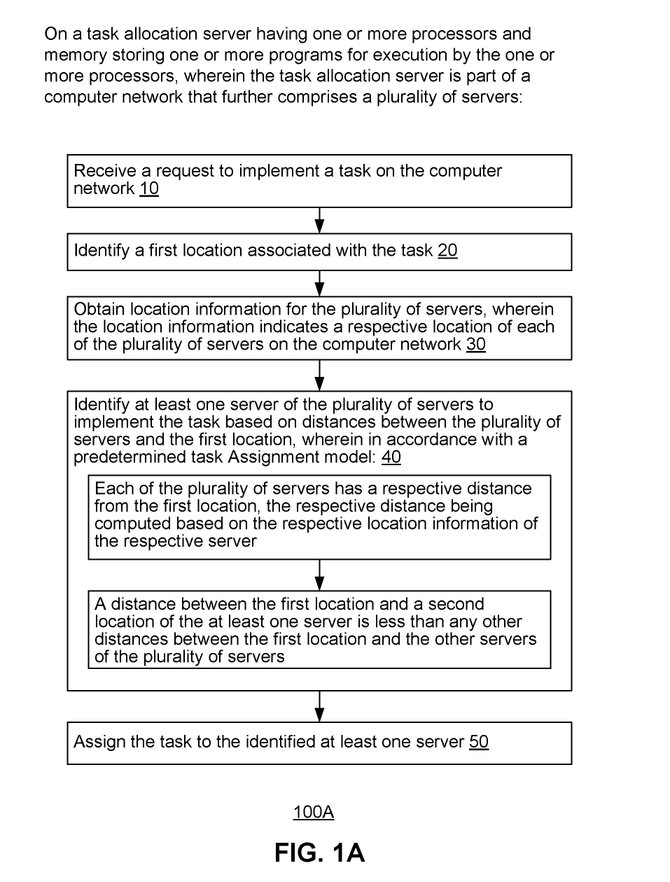

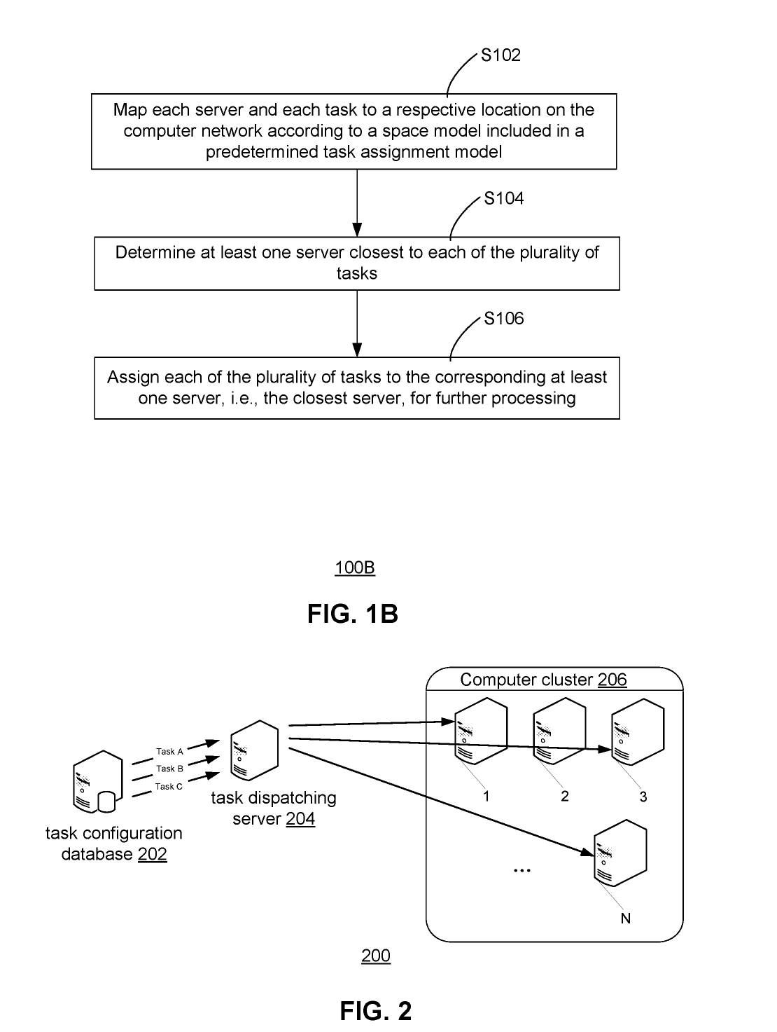

FIGS. 1A and 1B illustrate flow diagrams representing two exemplary methods 100A and 100B for assigning a task on a computer network in accordance with some embodiments of the application. Each of methods 100A and 100B is, optionally, governed by instructions that are stored in a non-transitory computer readable storage medium and that are executed by one or more processors of a task assignment server. Each of the operations shown in FIGS. 1A and 1B may correspond to instructions stored in a computer memory or non-transitory computer readable storage medium. The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 100A or 100B may be combined and/or the order of some operations may be changed.

The task assignment server that implements method 100A is part of the computer network which includes a plurality of servers. The task assignment server receives (10) a request to implement a task on the computer network. In response to the request, the task assignment server identifies (20) a first location associated with the task, and obtains (30) location information for the plurality of servers. The location information indicates a respective location of each of the plurality of servers on the computer network. Then, the task assignment server identifies (40) at least one server of the plurality of servers to implement the task based on distances between the plurality of servers and the first location. In accordance with a predetermined task assignment model, each of the plurality of servers has a respective distance from the first location, and the respective distance is computed based on the respective location information of the respective server. A distance between the first location and a second location of the at least one server is less than any other distances between the first location and the other servers of the plurality of servers. After identifying the at least one server, the task assignment server assigns (50) the task to this identified at least one server.

In some embodiments, the task is identified by a first identifier, and the plurality of servers are identified by a plurality of second identifiers, each of the first and second identifiers being associated with the respective location of the corresponding task or server on the computer network. Further, in some embodiments, each of the first and second identifiers is converted to a corresponding numeric identifier according to a hash function.

In some embodiments, the plurality of servers are arranged to a circular sequence of servers according to a space model, and in accordance with the space model, each of the plurality of servers is associated with a location on the circle of servers.

In some embodiments, a respective similarity level is computed between the identifier of the task and a identifier of each of the plurality of servers on the computer network, and in accordance with a determination that the at least one server has a preferred similarity level, it is determined that the distance between the first and the second locations is less than any other distances between the first location and the other servers.

In some embodiments, the task assignment server further removes the at least one server from the plurality of servers, and reassigns the task to a next adjacent server among the plurality of servers. A distance between the first location and a third location of the next adjacent server is less than any other distances between the first location and the remaining servers of the plurality of servers. Then, the task assignment server moves data associated with the task from the at least one server to the next adjacent server.

In some embodiments, the plurality of servers are identified by a plurality of first numeric identifiers, and the task is identified by a second numeric identifier, each of the first and the second numeric identifiers being associated with the respective location of the corresponding servers or task on the computer network. Further, in some embodiments, the magnitudes of the first numeric identifiers are arranged in an order related to a spatial order of the plurality of servers on the computer network, and the respective difference between the corresponding first numeric identifiers of every two adjacent servers is proportional to the distance between the respective two adjacent servers on the computer network. Under some circumstances, the magnitude of the second numeric identifier of the task is compared with the magnitudes of the first numeric identifiers of the plurality of servers, such that the task could be associated with two servers, including the at least one server because the magnitude of the second numeric identifier is between the two first numeric identifiers of the two servers. The at least one server is identified between the two servers, when a first difference between the second numeric identifier and the first numeric identifier of the at least one server is less than a second difference between the second numeric identifier and the first numeric identifier of the other server that is distinct from the at least one server in the two servers.

Further as shown in FIG. 1B, method 100B is implemented on a task assignment server to assign a plurality of tasks (including a first task) on a computer network that includes a plurality of servers. In some embodiments, each task is associated with a respective business operation. For example, each task is associated with an operation of an online game. The task assignment server maps (S102) each server and each task to a respective location on the computer network according to a space model included in a predetermined task assignment model. The predetermined task assignment model is used to represent at least the relationship between the servers and the tasks.

In accordance with the locations associated with the servers and the tasks, the task assignment server determines (S104) at least one server of the plurality of servers that is closest to each of the plurality of tasks. Then, the task assignment server assigns (S106) each of the plurality of tasks to the corresponding at least one server, i.e., the closest server, for further processing.

In accordance with the space model, each server has a corresponding server position on the computer network, and each task is also mapped to a corresponding task position on the computer network. Further, distances could also be calculated between two servers or between a server and a task based on the space model. In some embodiments, the positions of the servers and the tasks, and the distances among the servers and the tasks are associated with their actual positions and distances in the physical space, respectively. In some embodiments, the positions and the distances are associated with virtual positions and distances determined according to the space model of the predetermined task assignment model.

In accordance with an exemplary predetermined task assignment model, the task is assigned to the closest server for further processing. Here, method 100B is used to assign the tasks according to the tasks' positions and the servers' positions both determined by the task assignment model (and particularly the space mode). The task assignment model associates each task with a fixed position. When the number and the arrangement of the servers on the computer network do not change, the task would be consistently assigned to the closest server every time. On the other hand, in accordance with some embodiments of the application, when the servers on the computer network change (e.g., when a server is removed from or incorporated to the computer network), tasks assigned to a server that is impacted by the change of the servers have to be reassigned. For example, the tasks have to be reassigned, when they were originally assigned to a server that is later removed from the computer network or to a server that is adjacent to a newly added server on the computer network. Other than the tasks assigned to the servers that are impacted, most tasks assigned on the computer network do not need be migrated to different servers, because the predetermined task assignment model assigns these models to their closest server which is oftentimes not impacted by the change on the network.

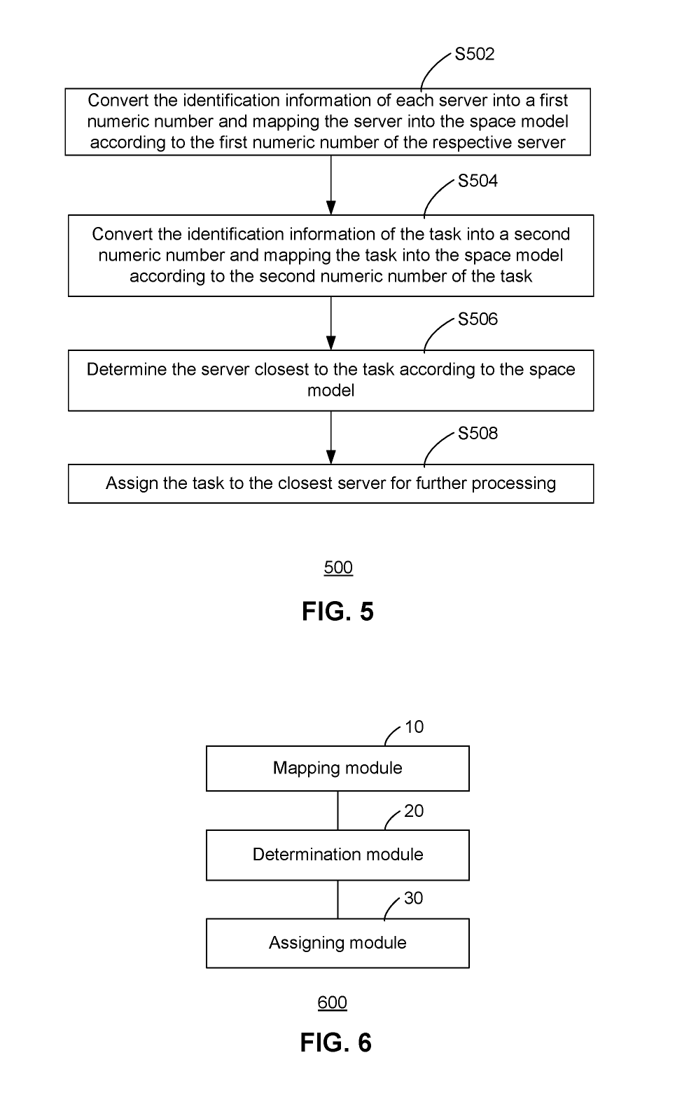

It should be understood that the particular order in which the operations in FIG. 1A or 1B have been described are merely exemplary and are not intended to indicate that the described order is the only order in which the operations could be performed. One of ordinary skill in the art would recognize various ways to cache and assign specific data as described herein. Additionally, it should be noted that details of other processes described herein with respect to one of methods 100A and 100B (e.g., FIGS. 1A and 1B) are also applicable in an analogous manner to the other of methods 100A and 100B, method 400 described below with respect to FIG. 4, and method 500 described below with respect to FIG. 5. For brevity, these details are not repeated here.

FIG. 2 illustrates an exemplary data analysis system 200 that analyzes data associated with tasks implemented on a computer network in accordance with some embodiments in the application. Data analysis system 200 includes a task configuration database 202, a task dispatching server 204, and a computer cluster 206 (including computers 1, 2, 3, . . . N). Computer cluster 206 is sometimes referred to as a server cluster that includes servers 1, 2, 3, . . . N. N is an integer and represents the total number of computers in computer cluster 206. In various embodiments of the application, task dispatching server 204 is sometimes called a task assignment server, and computer cluster 206 is part of a computer network.

Data analysis system 200 implements an exemplary task assignment method that includes the following operations:
Numbering and configuring (S202) machines in computer cluster 206 according to a sequence of integers (e.g., 1, 2, 3 . . . N);
Acquires (S204) by task dispatching server 204 computing task information of each game task (e.g., task A, B, C or the like) from task configuration database 202. Each game task (e.g., a task having a task name A) is associated with a respective task value Va calculated based on the predetermined task assignment model. In some embodiments, modulus-based algorithm is applied to obtain a modulus value for the task value Va based on the total number of computers in computer cluster 204 (i.e., N). The respective game task is assigned to a specific computer on computer cluster 206 according to the modulus value. In a specific example, when the modulus value is 1, the corresponding game task is therefore assigned to computer 1 of computer cluster 206; and
Consistently assigning (S206) each data analysis task of different game tasks included in task configuration database 202 into the same machine in computer cluster 206. This is particularly because the same mapping process of task name A→Va→1 will give the same result during each task assignment.

However, the above process of mapping a task to a computer in computer cluster 206 could fail. As shown below, corresponding failure rates are computed for some situations under which a computer is added to or removed from computer cluster 206, and then used to evaluate the corresponding impact to entire computer cluster 206 including the computers.

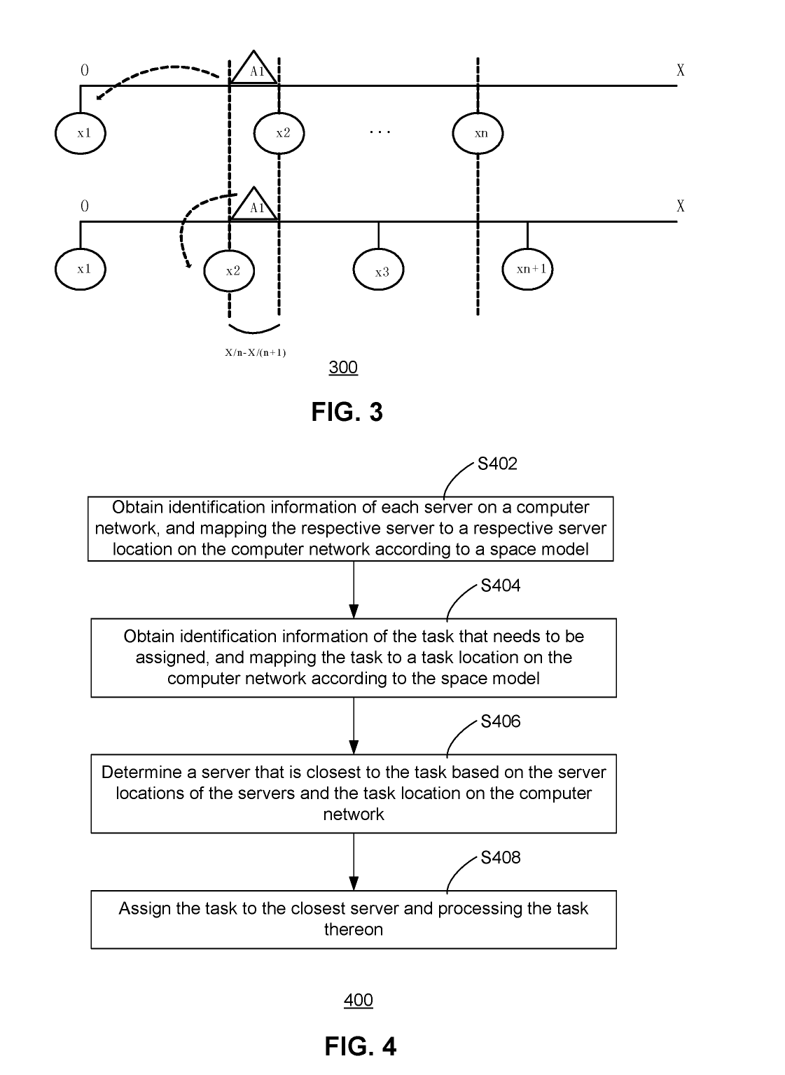

FIG. 3 illustrates an exemplary task assignment model 300 (including a space model). The space model is represented on a line starting at a head location 0 and ending at an end location X. An integer number (e.g., n) of machine nodes (consecutively represented by circles x1, x2, . . . , and xn) are uniformly distributed on the line. In some embodiments, a task assignment server associates a task A1 with a machine node x1 (represented by a triangle A1). Specifically, the task assignment server processes the name of task A1 according to a name conversion algorithm (e.g., a Hash algorithm) to obtain a value GameV corresponding to the task name, and then determines machine node x1 according to the remainder of the Euclidean division of GameV by integer n. In this situation, machine node x1 is the closest machine node that is located to the left of A1. In some embodiments, after one machine node is added into the line (e.g., a new machine is added to the computer network), the relative positions of machines x1, x2, . . . , xn in the space change with respect to each other. The location of task A1 relative to the machines is re-computed and associated with a distinct machine at machine node x2.

As shown in FIG. 3, when a new machine mode is added to the computer network (or the line), some tasks that were originally assigned to machine node x1 have to be reassigned to machine node x2, and they have a failure rate of X/n−X/(n+1) related to the shift of machine node x2 on the line (as shown by the space between vertical dashed lines). Thus, for each machine node, the failure rates of the mapping/matching relationship between the game tasks and the corresponding machine node could be computed as follows:

$$Px 1 = ( X \text{/} n - X \text{/} ( n + 1 ) ) \text{/} X = 1 \text{/} n - 1 \text{/} ( n + 1 )$$

$$Px 2 = 2 \text{/} n - 2 \text{/} ( n + 1 )$$

$$…$$

$$Px ( n - 1 ) = ( n - 1 ) \text{/} n - ( n - 1 ) \text{/} ( n + 1 )$$

$$Pxn = n \text{/} n - n \text{/} ( n + 1 ) = 1 - n \text{/} ( n + 1 )$$

where Px1, Px2, Px(n−1) and Pxn represent the failure rates for machine nodes x1, x2, x(n−1) and xn, respectively, and the integer n represents the number of machine nodes on the line (i.e., the computer network or computer cluster 206).

When a new machine node is inserted between two existing machine nodes, the mapping failure rate of the entire system is

$$\begin{matrix}PT = Px 1 + Px 2 + … + Px ( n - 1 ) + Pxn \\ = 1 \text{/} n - 1 \text{/} ( n + 1 ) + 2 \text{/} n - 2 \text{/} ( n + 1 ) + … + \\ ( n - 1 ) \text{/} n - ( n - 1 ) \text{/} ( n + 1 ) + n \text{/} n - n \text{/} ( n + 1 ) \\ = 1 \text{/} 2\end{matrix}$$

As a result, if 100 machines are in computer cluster 206, half of the machines, i.e. 50 machines, could possibly involve data maintenance and data migration, and result in a high maintenance cost. As the scale of computer cluster 206 increases, the maintenance cost would increase in proportion to the scale of the scale of the cluster.

According to task assignment model 300, the task assignment server does not necessarily assign a task to a closest server. For instance, the closest server to task A1 is x2 rather than x1 before a new machine is added into the computer network. If the task was mapped to x2, but not to x1, then data associated with task A1 does not need to be migrated to x2 during this process of increasing the number of the servers on the computer network. Therefore, task assignment to a closest machine (as implied in task assignment methods 100A and 100B) is more efficient than task assignment based on the modulus computation as shown in FIG. 3.

A task could be assigned to a server on a computer network according to various predetermined task assignment models. FIGS. 4 and 5 illustrate flow diagrams 400 and 500 representing another two exemplary methods for assigning a task on a computer network (sometimes called a computer cluster) in accordance with some embodiments in the application, respectively. Each of methods 400 and 500 is, optionally, governed by instructions that are stored in a non-transitory computer readable storage medium and that are executed by one or more processors of a task assignment server. Each of the operations shown in FIGS. 4 and 5 may correspond to instructions stored in a computer memory or non-transitory computer readable storage medium. The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 400 or 500 may be combined and/or the order of some operations may be changed.

In accordance with task assignment method 400, the task assignment server obtains (S402) identification information of each server on a computer network, and thereby maps (S402) the respective server to a respective server location on the computer network according to a space model. The position of each server is derived from the identification information of the server according to the space model. The task assignment server further obtains (S404) identification information of the task that needs to be assigned, and maps (S404) the task to a task location on the computer network according to the space model. The position of the task is derived from the identification information of the task according to the space model. Then, the task assignment server determines (S406) a server that is closest to the task based on the server locations of the servers and the task location on the computer network. The task is therefore assigned (S408) to the closest server and processed thereon. In various embodiments of the application, the space model is part of the predetermined task assignment model.

In some implementations, the task is mapped to the corresponding task location using its identification information according to the space model. The identification information includes the name of the task, so the tasks having the same name are assigned to the same server because their names include the identification information associated with the same task location. For those tasks that are expected to be assigned to the same server, the tasks need to be named in such a manner that their names include at least the identification information associated with the same task location. Further, in various embodiments of the application, the tasks are mapped according to the identification information in different manners. For example, in accordance with a specific space model, the identification information of the servers is optionally organized according to some arrangement rules before the servers are mapped to their respective server locations on the computer network. A similarity score is computed to indicate similarity between the identification information of the task and the identification information of the servers, and the server having the largest similarity score is determined as the closest server that is assigned with the task and implements the task on the computer network.

Further, in accordance with task assignment method 500, the task assignment server converts (S502) the identification information of each server on the computer network into a first numeric number, and map the respective server into the space model according to the first numeric number of the respective server. The task assignment server further converts (S504) the identification information of the task into a second numeric number and maps the task into the space model according to the second numeric number corresponding to the task. The task assignment server then determines (506) the server closest to the task according to the space model, and assigns (S508) the task to the closest server for further processing.

After the identification information for the servers and the task is converted into numeric numbers, it is more convenient to compute the distances between the task and the servers based on the numeric numbers, and thereby, determine the closest server to the task. For example, the closest server may be the server having a preferred absolute difference between the second numeric number corresponding to the task and the first numeric number corresponding to the closest server. In this specific example, operations S502-S506 are further modified as shown below.

The task assignment server determines (S502′) the first numeric number corresponding to each server, and in accordance with the space model, associates each server with a server location on the computer network based on the magnitude of the first numeric number. The order of the servers on the computer network matches the magnitudes of the first numeric numbers corresponding to the servers. The difference of the numeric numbers of two adjacent servers represents the distance between the two adjacent servers.

The task assignment server compares the numeric numbers of the task and the servers, and maps (S504′) the task to a task location between two servers according to the magnitudes of the numeric numbers. Among the servers on the computer network, the two servers have the first numeric numbers closest to the second numeric number of the task.

The task assignment server then selects (S506′) one of the two servers that is closer to the task location of the task to execute the task. Specifically, the task assignment server computes a respective difference between the second numeric number of the task and each of the first numeric numbers of the two servers. The one of the two servers that has a smaller difference is determined as the server that is closer to the task location.

Various name conversion methods could be applied to convert text into a numeric number. In some implementations, textual identification information is converted into a numeric number using a Hash function which converts the identification information of the servers and the identification information of the task into numeric numbers.

In accordance with an exemplary space model, the servers on the computer network are consecutively coupled to each other to form a closed ring. Stated another way, both the tasks and the servers on the computer network are mapped onto distinct locations of the closed ring according to the exemplary space model for the convenience of calculating their distances to each other.

In some implementations, when the servers on the computer network change (e.g., when more servers are added onto or removed from the computer network), the probability of migrating tasks among the servers is reduced, and however, data associated with some tasks still need to be migrated among the servers with the corresponding tasks that are impacted by the change of the servers. In contrast with some prior art in which data migration is implemented manually by an administrator, this application relies on an automatic data migration method. This automatic data migration method includes: after assigning a specific task to a first server that has a closest distance to a location of the specific task, determining that the first server is distinct from a second server that implement the specific task prior to the task assignment; and sending a data migration command to move data associated with the specific task from the second server to the first server. After receiving the data migration command, the second server automatically sends the data associated with the specific task to the first server without user intervention. This automatic data migration method not only reduces the maintenance cost but also improves the reliability for task management on the computer network.

This application also discloses a task assignment system that is used to implement the aforementioned task assignment methods. More details on the task assignment methods and the corresponding data migration methods are explained above with reference to FIGS. 1A, 1B, and 2-5. The task assignment system comprises modules having specific names. However, it should be noted that names of modules in the following task assignment system does not limit each module's functions to those functions suggested by their names. Each module may be referred to using a specific name or in any other manner that indicates its functions. For instance, a mapping module is optionally expressed as “module configured to map each server and each task according to a space model.” In some embodiments, the following modules are implemented in a processor, and thus, the mapping module is optionally expressed as “a processor, configured to map each server and each task in accordance with a space model,” “a processor, including a mapping module” or the like.

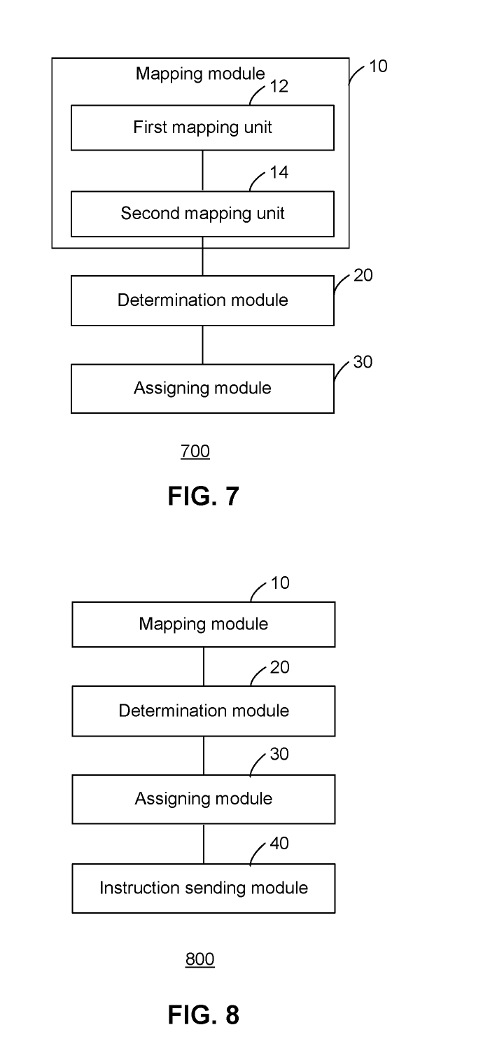

FIGS. 6-8 illustrate block diagrams for three exemplary task assignment systems 600, 700 and 800 in accordance with some embodiments in the application, respectively. Task assignment system 600 includes a mapping module 10, a determination module 20 and an assigning module 30. Mapping module 10 is configured to map each server and each task according to a space model that represents the relationship between each server and each task. Each server and each task have a corresponding position according to the space model. Determination module 20 is configured to determine a server on the computer network that is closest to a task that needs to be assigned according to the space model. Assigning module 30 is configured to assign the task to the closest server for processing.

The space model is part of a predetermined task assignment model. In accordance with the space model, each server has a respective position on the computer network. A task may also be mapped to a corresponding position on the computer network according to the space model. Further, distances between the task and each server on the computer network are calculated according to the space model, and a specific server that has a preferred distance to the task is selected to implement the task. In accordance with an exemplary task assignment model, the preferred distance is associated with a shortest distance that the servers on the computer network could have with respect to the task. Such a task assignment method maps the task to a fixed location on the computer network, and when no change (e.g., adding, removing or moving) occurs to the existing servers, the task is assigned to the same server selected according to the predetermined task assignment model (including the space model). Under many circumstances, even when a certain change occurs to the existing servers, the task that is already assigned to the specific server on the computer network does not need to be reassigned to another server based on the predetermined task assignment model.

Task assignment system 700 includes: a mapping module 10, a determination module 20 and an assigning module 30. In some implementations, mapping module 10 further includes a first mapping unit 12 and a second mapping unit 14, while determination module 20 and assigning module 30 have the same functions as those shown in FIG. 6. For Brevity, the details of modules 20 and 30 are not repeated here.

The first mapping unit 12 is configured to map each server into a space model according to its respective identification information, and specifically, the respective position of the server in the space model is determined according to the corresponding identification information of the server.

The second mapping unit 14 is configured to map a task that needs to be assigned according to the space model based on identification information of the task, wherein the position of the task in the space model is determined according to the corresponding identification information of the task.

In accordance with task assignment system 700, the task is mapped into the space model by using the identification information, and specifically, the identification information may be the name of the task. Different tasks having the same name are therefore assigned to the same server, when the tasks and the servers are denominated according to the names. Thus, when two tasks need to be assigned to the same server, the two tasks should be identified using the same name. Further, in various embodiments, the tasks are mapped into the space model according to the identification information by different means. Specifically, the identification information of the servers and the tasks are defined according to specific identification rules and then mapped into the space model. In some embodiments, in accordance with an exemplary task assignment model, a respective similarity level is computed between the identification information of the task that needs to be assigned and the identification information of the servers on the computer network, and the server that has a preferred similarity level (e.g., a largest similarity level) is selected to implement the task. Stated another way, the server having the preferred similarity level with respect to its identification information is regarded as a server having a preferred distance to the task or a shortest distance to the task.

In some implementations, the first mapping unit 12 is configured to convert the identification information of each server into a first numeric number and map each server into the space model according to the corresponding first numeric number. The second mapping unit 14 is configured to convert the identification information of the task into a second numeric number and map the task into the space model according to the second numeric number. After the identification information is converted into numeric numbers, the distances between the task and the servers are conveniently computed according to regular mathematic rules applicable to the numeric numbers. In a specific example, the server having the preferred distance from the task's location is the server having a minimum absolute difference between each of the first numeric numbers and the second numeric number. The first mapping unit 12, the second mapping unit 14 and determination module 20 are configured to determine the server that the task would be assigned to.

Specifically, in some embodiments, the first mapping unit 12 is configured to order the first numeric numbers that identifies the servers on the computer network according to the magnitude thereof, and map the first numeric numbers into the space model. Here, a difference of the first numeric numbers of two adjacent servers represents the distance between the two adjacent servers. The second mapping unit 14 is configured to map the task into the space model according to the second numeric number. In some embodiments, the task is automatically mapped between two servers on the computer network, because the magnitude of the second numeric number is larger than one but smaller than the other one of the two first numeric numbers of the two servers. Determination module 20 is configured to compute the differences between the first numeric numbers of the two servers and the second numeric number of the task. The server associated with a smaller difference is determined as the closest server, and is assigned to implement the task.

Task assignment system 800 includes: a mapping module 10, a determination module 20, an assigning module 30 and an instruction sending module 40. More details on modules 20 and 30 are discussed above with reference to FIG. 6. Instruction sending module 40 is configured to, if a task originally assigned to a first server is reassigned to a second server, send a data migration instruction to the second server for processing the task, wherein the data migration instruction is configured to instruct the second server to receive data associated with the task from the first server.

More details on task assignment are further explained below for an online game data analysis system which is specially configured to compute a virtual distance between a gaming data analysis task and a computational machine, and establish a task-machine matching relationship.

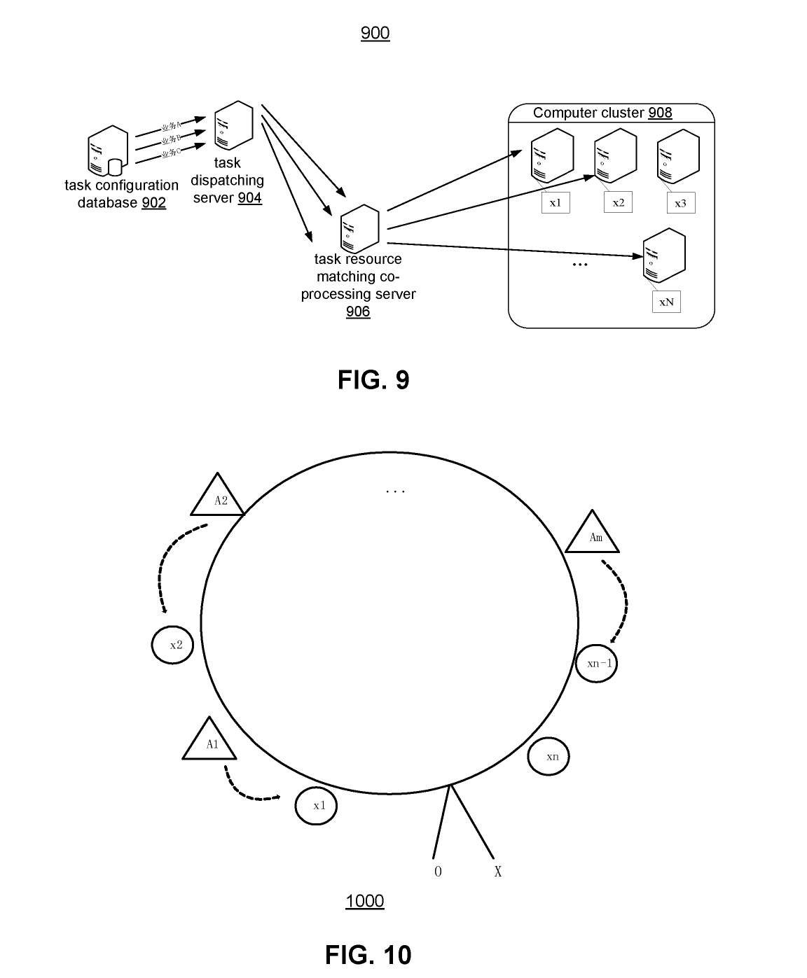

FIG. 9 illustrates an exemplary data analysis system 900 that analyzes gaming data associated with an online game implemented on a computer network in accordance with some embodiments in the application. Data analysis system 900 includes a task configuration database 902, a task dispatching server 904, a task resource matching co-processing server 906 and a computer cluster 908 (including machines x1, x2, x3, . . . , and xN). Task configuration database 902 has the same functions as task configuration database 202 used in task assignment system 200 as shown in FIG. 2. Task dispatching server 904 is configured to send a task name and other task configuration information to task resource matching co-processing server 906. Task resource matching co-processing server 906 is configured to assign the machine resources for each task after task-machine matching according to the virtual distance between the task and at least one of the machine resources. Thus, some functions of task assignment system 900 are realized through task resource matching co-processing server 906.

More details on task assignment system 900 are explained below with reference to FIG. 9. Specifically, task assignment system 900 is applied for online gaming data analysis, and includes task configuration database 902 that is configured to store information concerning each game task in need of data analysis, wherein the information concerning the respective game includes, but is not limited to, game task identification, task name, dispatching frequency, analysis index, rule and the like, and could be used for adding, deleting and scheduling the respective game task.

Task assignment system 900 applied for online gaming data analysis further includes task dispatching server 904. In some embodiments, server 904 is configured to (1) regularly acquire information concerning an online game and each game task corresponding to the online game from task configuration database 902, and identify one or more game tasks that need to be implemented. In some embodiments, server 904 is configured to (2) in accordance with information concerning a game task that needs to be implemented, generate an execution instruction for the task according to predetermined business rules associated with the online game, and send the execution instruction to task resource matching co-processing server 906.

Task assignment system 900 applied for online gaming data analysis further includes task resource matching co-processing server 906. In some embodiments, server 906 is configured to (1) regularly acquire configuration information for machines in computer cluster 908, and compute the virtual distances of the machines in computer cluster 908 in accordance with a space model of a predetermined task assignment model. In some embodiments, server 906 is configured to (2) receive the information concerning the game task and the execution instruction from task dispatching server 904, compute the virtual distances between the game task and the machines on computer cluster 908, assign the game task to a corresponding machine according to the matching rules of the predetermined task assignment model, send the game task and its corresponding execution instruction while recording the association between the game task and the corresponding machine on computer cluster 908, and store a copy of the information concerning the game task and the corresponding execution instruction. In some embodiments, server 906 is configured to (3) implement an automatic data migration function in which when configuration information of machines on computer cluster 908 changes, server 906 re-computes and compares the virtual distances between the game task and each machine on computer cluster 908 to determine a second machine on computer cluster 908 to implement the game task. It is further determined whether the second machine is distinct from the machine (e.g., a first machine) that is previously assigned to implement the game task prior to the change of the machines' configuration information change.

Under some situations, the matching relationship is changed (i.e., the first and the second machines are distinct). Stated another way, the game task (e.g., a game task A1) is originally assigned to a first machine x1, and however, the second machine corresponding to the game task A1 is x2 due to the change of the configuration information of computer cluster 908. Server 906 is configured to determine whether data migration should be performed. In some situations, the second machine implements the game task, and fetch data associated with the game task from the first machine as needed. In some situations, the data associated with the game task are moved from the first server to the second server. Then, server 906 is configured to send a data migration instruction to the second machine x2 to enable the second machine x2 to pull the historical data required for normal execution of the data analysis task of the game task A1 from the first machine x1.

Task assignment system 900 applied for online gaming data analysis further includes machines (x1-xN) on computer cluster 908. (1) Computer cluster 908 is a main body for executing the actual game task associated with gaming data analysis, and includes a plurality of physical machines. Each physical machine further includes a computing server that could be selected to implement the game task. (2) In some embodiments, a specific machine on computer cluster 908 receives information concerning the game task for gaming data analysis sent by task resource matching co-processing server 906, puts the tasks in a local task queue, and executes the tasks in the local task queue consecutively. (3) In accordance with an automatic data migration function, when a machine on computer cluster 908 receives the data migration instruction from task resource matching co-processing server 906, the machine creates a new migration process, and requests the historical data associated with a game task from another machine, and stores the data to a local memory according to the corresponding execution instruction of the game task.

In various embodiments of this application, the term of “computer network” is used in an exchangeable manner with the term of “computer cluster.”

FIG. 10 illustrates a space model 1000 of an exemplary data analysis system that analyzes gaming data according to the embodiments of the application. According to space model 1000, machines on a computer network (sometimes called a computer cluster) are mirrored to positions on a virtual loop (e.g., a ring). A head machine includes machine x1, an end machine includes machine xn. A virtual distance between two machines or between a task and a machine are measured based on their respective positions on the virtual loop.

In space model 1000 shown in FIG. 10, a triangle represents a position of the task casted on the virtual loop according to a corresponding mapping algorithm, and a circle represents the position of a machine similarly casted on the virtual loop according to the corresponding mapping algorithm. Optionally, a virtual distance between two positions on the loop is defined as:

Dh=min{(H2−H1),(H1+X−H2)}

wherein Dh represents the distance between two positions on the virtual loop, and H1 and H2 represents coordinate values of the two positions. Optionally, H1 and H2 are associated with the hash values associated with the corresponding identification information, and H2 is larger than H1 (i.e., H2>H1). X is the computed specific hash value that represents the size of the hash space, i.e., the virtual loop established according to space model 1000. In some embodiments, X is a numeric number computed from the identification information of machines on a computer network. For example, the numeric number associated with X is the maximum value among the numeric values computed from the identification information of machines on a computer network.

In some embodiments, the closest distance of the two points on the loop is defined as a space distance.

The predetermined task assignment model that assigns a task according to virtual distances relies on an operation of associating a task with one of its two neighboring machine nodes that has a preferred space distance (e.g., a smaller distance) to the task node. If the distances from the two neighboring machine nodes are equal for the task node, then the predetermined task assignment model optionally requires adoption of a counter-clockwise assignment, i.e., the task would be assigned to the neighboring node that is next to the task on an counter-clockwise direction. According to such a counter-clockwise assignment, a task A1 is matched to the machine x1, a task A2 is matched to the machines x2, and a task Am is matched to xn−1.

Referring to FIG. 10, a task assignment method includes at step S1002, denominating the machines on a computer network according to a naming convention. For example, machines are named as x1, x2, x3, . . . , and xn. Then, at step 1004, task dispatching server 904 processes task information of each game task which needs to be implemented, and sends the resulting data associated with the task name and task configuration information to task resource matching co-processing server 906. At step 1006, task resource matching co-processing server 908 computes and maps the task onto a position Va according to the task name or other identification information of the task based on a mapping algorithm (e.g., a hash algorithm). Meanwhile, task resource matching co-processing server 906 also computes positions Vxl from the names or identification information of the computer cluster machines on the same virtual space. Server 906 then computes the virtual distances of the task to each computing machine according to the definition of virtual distances, and in accordance with a predetermined task assignment model, assigns the task to the computing machine having a preferred virtual distance (e.g., the minimum virtual distance) from the task (refer to FIG. 4).

At step 1008, a computing machine (e.g., machine x1) receives a task for data analysis (e.g., task A1), places the task in a task execution queue, and executes the task in sequence.

In the case that the computer cluster machines are not changed, the virtual distance between the task and the machine is fixed. Therefore, a state-based (such as historical data) game data analysis task may be executed in the same computing machine at each time, which saves the data transmission time and is beneficial for improving the computational efficiency of the entire system.

Some prior art is plagued with failures in consistently assigning a task to a computer server. However, the impact of such failures is reduced in various embodiments of task assignment systems in this application, while the cost to maintain these task assignment systems is relatively low. More details on the impact and the cost of the task assignment systems disclosed herein are explained below.

In some situations, one machine is added into a computer network. Referring to FIG. 4, supposing the current abstract space based on the computer network includes an integer number (e.g., n) of machine nodes, and the positions of the nodes are represented by x1, x2, . . . x(n−1), xn (x1<x2<x(n−1)<xn). X represents the magnitude of the space. Then, if the newly added machine node is located between positions x1 and x2, then the failure rates P12, P23, . . . P(n−1)n and Pn1 associated with every two neighboring machine nodes are

$$P 12 = ( x2 - x1 ) \text{/} ( 2 X ) . \\ P 23 = ( x 3 - x 2 ) \text{/} ( 2 X ) , \\ …$$

$$P ( n - 1 ) n = ( xn - x ( n - 1 ) ) \text{/} ( 2 X ) , \\ Pn 1 = ( X + x 1 - xn ) \text{/} ( 2 X ) .$$

After one machine node is randomly added, the expected failure rate P of the original mapping relationship is as follows:

$$\begin{matrix}P = ( P 12 + P 23 + … + P ( n - 1 ) n + Pn 1 ) \text{/} n \\ = ( ( x 2 - x 1 ) \text{/} ( 2 X ) + ( x 3 - x 2 ) \text{/} ( 2 X ) + … + \\ ( xn - x ( n - 1 ) ) \text{/} ( 2 X ) + ( X + x 1 - xn ) \text{/} ( 2 X ) ) \text{/} n \\ = 1 \text{/} ( 2 n )\end{matrix}$$

It can be seen that supposing the cluster has 100 machines originally, then 1/200 of the tasks may be re-mapped to a new machine for execution once one machine is increased. That is, the data of 0.5 machine needs migration and manual maintenance. Similarly, in the situation of removing one machine, the probability is also 1/200. Moreover, the failure rate is linearly reduced along with the increasing of the scale n of the computer cluster. Comparatively, in the solution of the prior art, if there are 100 machines in the computer cluster, then half machines, i.e. 50 machines, may possibly need manual maintenance and data migration. The cost may be very high. Moreover, with the increased scale of the computer cluster, the cost may be increased linearly. Therefore, taking a cluster having a scale of 100 machines for example, the technical solution of the present application only has 0.5 machines that need data migration and manual maintenance. However, 50 machines in the solution of the prior art need data migration and manual maintenance. Therefore, the efficiency of operation is improved by 100 times. Moreover, because the task resource matching co-processing server and the computing server in the technical solution of the present application have the automatic data migration function, so that is not necessary for the data migration in the application scenarios of increasing the quantity of the computer cluster machines. In this way, the manpower cost for operation is further reduced.

Extra expenditure and cost of the system caused by the configuration change of the computer cluster during the operation process may be reduced through the game data analysis system and method based on virtual distance matching provided in the preferred embodiments of the application. In addition, the entire operation efficiency of the system is also increased due to the reduction of the data migration volume.

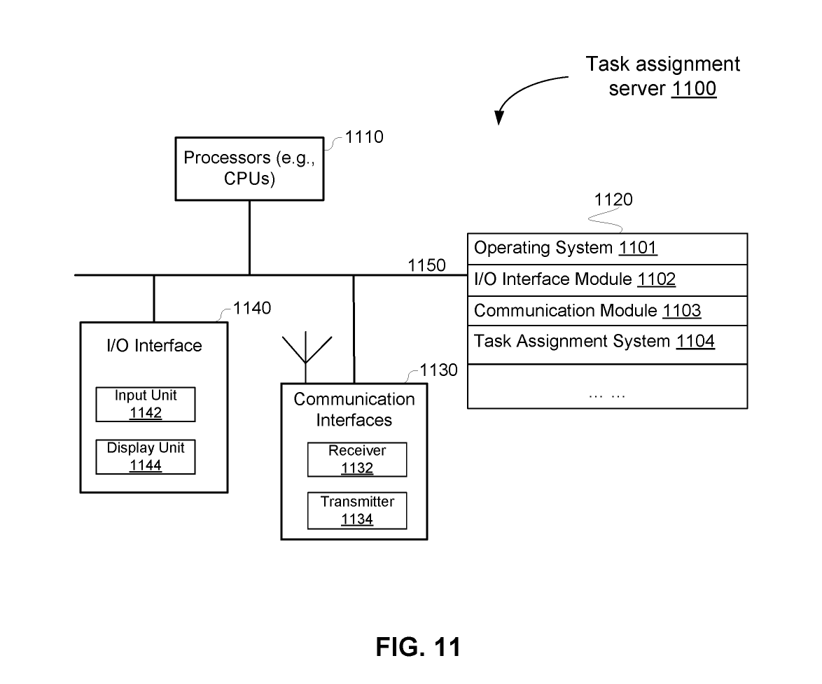

FIG. 11 illustrates a block diagram of a task assignment server 1100 that includes a task assignment module in accordance with some embodiments in the application. In some implementations, server system 1100 at least includes one or more processors 1110 (e.g., central processing units) and a memory 1120 for storing data, programs and instructions for execution by one or more processors 1110. In some implementations, server system 1100 further includes one or more communication interfaces 1130, an input/output (I/O) interface 1140, and one or more communication buses 1150 that interconnect these components.

In some embodiments, I/O interface 1140 includes an input unit 1142 and a display unit 1144. Examples of input unit 1142 include a keyboard, a mouse, a touch pad, a game controller, a function key, a trackball, a joystick, a microphone, a camera and the like. Additionally, display unit 1144 displays information that is inputted by the user or provided to the user for review. Examples of display unit 1144 include, but are not limited to, a liquid crystal display (LCD) and an organic light-emitting diode (OLED) display. In some implementations, input unit 1142 and display unit 1144 are integrated on a touch-sensitive display that displays a graphical user interface (GUI).

In some embodiments, communication buses 1150 include circuitry (sometimes called a chipset) that interconnects and controls communications between system components. In some embodiments, communication interfaces 1130 further include a receiver 1132 and a transmitter 1134.

In some embodiments, memory 1120 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. In some embodiments, memory 1120 includes one or more storage devices remotely located from the one or more processors 1110. In some embodiments, memory 1120, or alternatively the non-volatile memory device(s) within memory 1120, includes a non-transitory computer readable storage medium.

In some embodiments, memory 1120 or alternatively the non-transitory computer readable storage medium of memory 1120 stores the following programs, modules and data structures, instructions, or a subset thereof:
Operating System 1101 that includes procedures for handling various basic system services and for performing hardware dependent tasks;
I/O interface module 1102 that includes procedures for handling various basic input and output functions through one or more input and output devices, wherein I/O interface module 1102 further includes an interface display module that controls displaying of a graphical user interface;
Communication module 1103 that is configured to connecting server system 1100 to other computational devices (e.g., servers and client devices), via one or more network communication interfaces 1150 (wired or wireless) and one or more communication networks, such as the Internet, other wide area networks, local area networks, metropolitan area networks, and so on; and
Task assignment system 1104 that assigns a task to at least one of a plurality of computer servers on a computer network according to a predetermined task assignment model.

More details on task assignment system 1104 are explained above with reference to FIGS. 1A, 1B, and 2-10.

While particular embodiments are described above, it will be understood it is not intended to limit the application to these particular embodiments. On the contrary, the application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although the terms the first, the second, etc. may be used herein to describe various elements, these elements should not be limited by these terms. These terms are only used to distinguish one element from another. For example, the first ranking criteria could be termed the second ranking criteria, and, similarly, the second ranking criteria could be termed the first ranking criteria, without departing from the scope of the present application. The first ranking criteria and the second ranking criteria are both ranking criteria, but they are not the same ranking criteria.

The terminology used in the description of the application herein is for the purpose of describing particular embodiments only and is not intended to be limiting of the application. As used in the description of the application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the application to the precise forms disclosed. Many modifications and variations are possible in view of the above teachings. The implementations were chosen and described in order to best explain principles of the application and its practical applications, to thereby enable others skilled in the art to best utilize the application and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A computer-implemented method for assigning a task, comprising:
on a task assignment server having one or more processors and memory storing one or more programs for execution by the one or more processors, wherein the task assignment server is part of a computer network that further comprises a plurality of servers:
receiving a request to implement a task on the computer network;
identifying a first location associated with the task;
obtaining location information for the plurality of servers, wherein the location information indicates a respective location of each of the plurality of servers on the computer network;
identifying at least one server of the plurality of servers to implement the task based on distances between the plurality of servers and the first location, wherein in accordance with a predetermined task assignment model:
each of the plurality of servers has a respective distance from the first location, the respective distance being computed based on the respective location information of the respective server, and
a distance between the first location and a second location of the at least one server is less than any other distances between the first location and the other servers of the plurality of servers; and
assigning the task to the identified at least one server.

2. The method of claim 1, wherein the task is identified by a first identifier, and the plurality of servers are identified by a plurality of second identifiers, each of the first and second identifiers being associated with the respective location of the corresponding task or server on the computer network.

3. The method of claim 1, wherein each of the first and second identifiers is converted to a corresponding numeric identifier according to a hash function.

4. The method of claim 1, wherein a respective similarity level is computed between an identifier of the task and an identifier of each of the plurality of servers on the computer network, and in accordance with a determination that the at least one server has a preferred similarity level, it is determined that the distance between the first and the second locations is less than any other distances between the first location and the other servers.

5. The method of claim 1, wherein the plurality of servers are arranged to a circular sequence of servers according to a space model of the predetermined task assignment model, and in accordance with the space model, each of the plurality of servers is associated with a location on the circle of servers.

6. The method of claim 1, further comprising:
removing the at least one server from the plurality of servers;
reassigning the task to a next adjacent server among the plurality of servers, wherein a distance between the first location and a third location of the next adjacent server is less than any other distances between the first location and the remaining servers of the plurality of servers; and
moving data associated with the task from the at least one server to the next adjacent server.

7. The method of claim 1, wherein the plurality of servers are identified by a plurality of first numeric identifiers, and the task is identified by a second numeric identifier, each of the first and the second numeric identifiers being associated with the respective location of the corresponding servers or task on the computer network.

8. The method of claim 7, wherein the magnitudes of the first numeric identifiers are arranged in an order related to a spatial order of the plurality of servers on the computer network, and the respective difference between the corresponding first numeric identifiers of every two adjacent servers is proportional to the distance between the respective two adjacent servers on the computer network.

9. The method of claim 8, wherein identifying the at least one server of the plurality of servers further comprises:
comparing the magnitude of the second numeric identifier of the task with the first numeric identifiers of the plurality of servers;
associating the task with two servers, including the at least one server, wherein the magnitude of the second numeric identifier is between the two first numeric identifiers of the two servers; and
identifying the at least one server between the two servers, wherein the second numeric identifier and the first numeric identifier of the at least one server have a first difference, and the second numeric identifier and the first numeric identifier of the other server distinct from the at least one server in the two servers has a second difference, and wherein the first difference is less than the second difference.

10. A server system, wherein the server system comprises a first server, comprising:
one or more processors; and
memory having instructions stored thereon, which when executed by the one or more processors cause the processors to perform operations comprising:
receiving a request to implement a task on the computer network;
identifying a first location associated with the task;
obtaining location information for the plurality of servers, wherein the location information indicates a respective location of each of the plurality of servers on the computer network;
identifying at least one server of the plurality of servers to implement the task based on distances between the plurality of servers and the first location, wherein in accordance with a predetermined task assignment model:
each of the plurality of servers has a respective distance from the first location, the respective distance being computed based on the respective location information of the respective server, and
a distance between the first location and a second location of the at least one server is less than any other distances between the first location and the other servers of the plurality of servers; and
assigning the task to the identified at least one server.

11. The server system of claim 10, wherein the task is identified by a first identifier, and the plurality of servers are identified by a plurality of second identifiers, each of the first and second identifiers being associated with the respective location of the corresponding task or server on the computer network.

12. The server system of claim 11, wherein each of the first and second identifiers is converted to a corresponding numeric identifier according to a hash function.

13. The server system of claim 10, wherein a respective similarity level is computed between an identifier of the task and an identifier of each of the plurality of servers on the computer network, and in accordance with a determination that the at least one server has a preferred similarity level, it is determined that the distance between the first and the second locations is less than any other distances between the first location and the other servers.

14. The server system of claim 10, wherein the plurality of servers are arranged to a circular sequence of servers according to a space model, and in accordance with the space model, each of the plurality of servers is associated with a location on the circle of servers.

15. The server system of claim 10, wherein the task is identified by a first numeric identifier, and the plurality of servers are identified by a plurality of second numeric identifiers, each of the first and the second numeric identifiers being associated with the respective location of the corresponding task or server on the computer network.

16. A non-transitory computer-readable medium, having instructions stored thereon, which when executed by one or more processors cause the processors to perform operations comprising:
receiving a request to implement a task on the computer network;
identifying a first location associated with the task;
obtaining location information for the plurality of servers, wherein the location information indicates a respective location of each of the plurality of servers on the computer network;
identifying at least one server of the plurality of servers to implement the task based on distances between the plurality of servers and the first location, wherein in accordance with a predetermined task assignment model:
each of the plurality of servers has a respective distance from the first location, the respective distance being computed based on the respective location information of the respective server, and
a distance between the first location and a second location of the at least one server is less than any other distances between the first location and the other servers of the plurality of servers; and
assigning the task to the identified at least one server.

17. The non-transitory computer-readable medium of claim 16, wherein the operations performed by the processors further comprises:
removing the at least one server from the plurality of servers;
reassigning the task to a next adjacent server among the plurality of servers, wherein a distance between the first location and a third location of the next adjacent server is less than any other distances between the first location and the remaining servers of the plurality of servers; and
moving data associated with the task from the at least one server to the next adjacent server.

18. The non-transitory computer-readable medium of claim 16, wherein the plurality of servers are identified by a plurality of first numeric identifiers, and the task is identified by a second numeric identifier, each of the first and the second numeric identifiers being associated with the respective location of the corresponding servers or task on the computer network.

19. The non-transitory computer-readable medium of claim 18, wherein the magnitudes of the first numeric identifiers are arranged in an order related to a spatial order of the plurality of servers on the computer network, and the respective difference between the corresponding first numeric identifiers of every two adjacent servers is proportional to the distance between the respective two adjacent servers on the computer network.

20. The non-transitory computer-readable medium of claim 19, wherein the operation of identifying the at least one server of the plurality of servers further comprises:
comparing the magnitude of the second numeric identifier of the task with the first numeric identifiers of the plurality of servers;
associating the task with two servers, including the at least one server, wherein the magnitude of the second numeric identifier is between the two first numeric identifiers of the two servers; and
identifying the at least one server between the two servers, wherein the second numeric identifier and the first numeric identifier of the at least one server have a first difference, and the second numeric identifier and the first numeric identifier of the other server distinct from the at least one server in the two servers has a second difference, and wherein the first difference is less than the second difference.
